(19) United States
(12) Patent Application Publication
(10) Pub. No.: US 2009/0212235 A1
(43) Pub. Date: Aug. 27, 2009

(54) SCANNING FLUORESCENT READER WITH DIFFUSER SYSTEM

(75) Inventor: Paul J. Patt, Walnut Creek, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Bio-Rad Laboratories, Inc., Hercules, CA (US)

(21) Appl. No.: 12/372,101

(22) Filed: Feb. 17, 2009

Related U.S. Application Data
(60) Provisional application No. 61/029,246, filed on Feb. 15, 2008.

(51) Int. Cl. G01J 1/58

(52) U.S. Cl. 250/459.1; 250/458.1

(57) ABSTRACT

A fluorescence detection apparatus includes a support structure attachable to the thermal cycler and a detection module movably mountable on the support structure. The detection module includes one or more channels, each having an excitation light generator and an emission light detector both disposed within the detection module. The excitation light generator includes a diffuser to provide a more uniform light distribution. When the support structure is attached to the thermal cycler and the detection module is mounted on the support structure, the detection module is movable so as to be positioned in optical communication with different ones of the plurality of wells. The detection module can interrogate different wells while in motion over the wells.

This application claims the benefit of U.S. Provisional Application No. 61/029,246 entitled “Scanning Fluorescent Reader With Diffuser System,” filed on Feb. 15, 2008, the disclosure of which is incorporated by reference herein in its entirety.

### BACKGROUND OF THE INVENTION

The present invention relates in general to fluorescence detection systems and in particular to a fluorescence detection system for use with a thermal cycler. The fluorescence detection system has a movable excitation/detection module with an excitation light diffuser. The excitation/detection module can operate in a continuous scanning mode.

Thermal cyclers are known in the art. Such devices are used in a variety of processes for creation and detection of various molecules of interest, e.g., nucleic acid sequences, in research, medical, and industrial fields. Processes that can be performed with conventional thermal cyclers include but are not limited to amplification of nucleic acids using procedures such as the polymerase chain reaction (PCR). Such amplification processes are used to increase the amount of a target sequence present in a nucleic acid sample.

Numerous techniques for detecting the presence and/or concentration of a target molecule in a sample processed by a thermal cycler are also known. For instance, fluorescent labeling may be used. A fluorescent label (or fluorescent probe) is generally a substance which, when stimulated by an appropriate electromagnetic signal or radiation, absorbs the radiation and emits a signal (usually radiation that is distinguishable, e.g., by wavelength, from the stimulating radiation) that persists while the stimulating radiation is continued, i.e. it fluoresces. Some types of fluorescent probes are generally designed to be active only in the presence of a target molecule (e.g., a specific nucleic acid sequence), so that a fluorescent response from a sample signifies the presence of the target molecule. Other types of fluorescent probes increase their fluorescence in proportion to the quantity of double-stranded DNA present in the reaction. These types of probes are typically used where the amplification reaction is designed to operate only on the target molecule.

Fluorometry involves exposing a sample containing the fluorescent label or probe to stimulating (also called excitation) radiation, such as a light source of appropriate wavelength, thereby exciting the probe and causing fluorescence. The emitted radiation is detected using an appropriate detector, such as a photodiode, photomultiplier, charge-coupled device (CCD), or the like.

Fluorometers for use with fluorescent-labeled samples are known in the art. U.S. Pat. No. 7,148,043 (issued Dec. 12, 2006) discloses a fluorometer that has a movable excitation/detection module that can be mounted on a thermal cycler instrument. The excitation/detection module provides a light source and a light detector. The module is movable to be placed in optical communication with each of a number of sample wells of the thermal cycler. The light source produces light that excites the fluorescent probe, and the light detector detects the fluorescent light. The module can be moved from well to well and can interrogate each well in turn. It is possible to keep the module substantially continuously in motion, scanning and interrogating each well in turn.

### BRIEF SUMMARY OF THE INVENTION

The fastest way to scan and interrogate a rectangular array of sample wells is in a serpentine pattern. The excitation/detection module can scan left-to-right (or right-to-left) across a first row of wells, after which it can shift to the next row and scan the wells of that row in the opposite direction and so on. It has been discovered that when using this serpentine scanning pattern, systematic biases in the measurements of fluorescent light can occur depending on the direction in which the excitation/detection module traverses a particular well (e.g., right-to-left or left-to-right). This bias is a result of non-uniformity of the excitation light source.

To reduce or eliminate this bias, a diffuser can be placed between the light source and the target (e.g., sample wells). The diffuser is advantageously incorporated into the excitation/detection module so that the optical path remains the same as the module moves from one target to the next.

The following detailed description together with the accompanying drawings will provide a better understanding of the nature and advantages of the present invention.

### BRIEF DESCRIPTION OF THE DRAWINGS

FIG. 1 is a perspective view of a thermal cycling apparatus incorporating an embodiment of the present invention.

FIG. 2 is an exploded view of the inside of the lid assembly of the apparatus of FIG. 1.

FIG. 3 is a diagram of an excitation/detection pair incorporating a diffuser according to an embodiment of the present invention.

FIG. 4 illustrates a serpentine scanning pattern according to an embodiment of the present invention.

FIG. 5 is a graph showing amplification measurements as a function of number of cycles of a thermal cycler for each sample well of an array, with no diffuser.

FIG. 6 shows light intensity as a function of position for the type of LED used to generate the results shown in FIG. 5.

FIGS. 7A and 7B are graphs showing light intensity and simulated detector response as functions of time for two different intensity profiles.

FIG. 8 is a graph comparing detected response from a test well for right-to-left and left-to-right scanning movements, with a mechanically eccentric and spatially inhomogeneous LED.

FIG. 9 is a graph comparing detected response from a test well for right-to-left and left-to-right scanning movements, with a mechanically centered but spatially inhomogeneous LED.

FIG. 10 shows light intensity as a function of position for the same LED as in FIG. 6, but with a diffuser in place.

FIG. 11 is a graph showing amplification measurements as a function of number of cycles of a thermal cycler for each sample well of an array, with a diffuser.

### DETAILED DESCRIPTION OF THE INVENTION

### Apparatus Overview

The present invention is suitable for use in a thermal cycler apparatus, such as that shown in U.S. Pat. No. 7,148,043, the disclosure of which is incorporated herein by reference in its entirety. For convenience, a summary description of that apparatus follows.

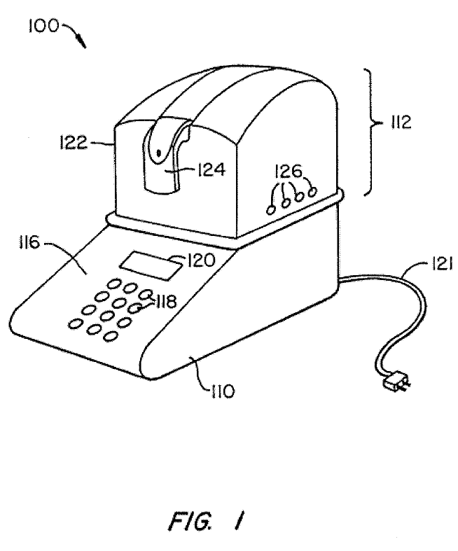

FIG. 1 is a perspective view of a thermal cycling apparatus 100 incorporating an embodiment of the present invention. Apparatus 100 consists of a base unit 110 and a lid assembly 112. Base unit 110, which may be of conventional design, provides power and control functions for a thermal cycling process via conventional electronic components (not shown), such as programmable processors, clocks, timers, and the like. Base unit 110 also provides a user interface 116 that may include a keypad 118 and an LCD display screen 120, enabling a user to control and monitor operation of the thermal cycler. Base unit 110 connects to an external power source (e.g., standard 120 V ac power) via a power cable 121.

Lid assembly 112 includes a sample unit and a fluorescence detection apparatus, disposed within a lid 122; these components will be described below. Lid 122 has a handle 124 to aid in its placement on and removal from base unit 110, and ventilation holes 126. Lid 122 provides optical and thermal isolation for the components inside lid assembly 112.

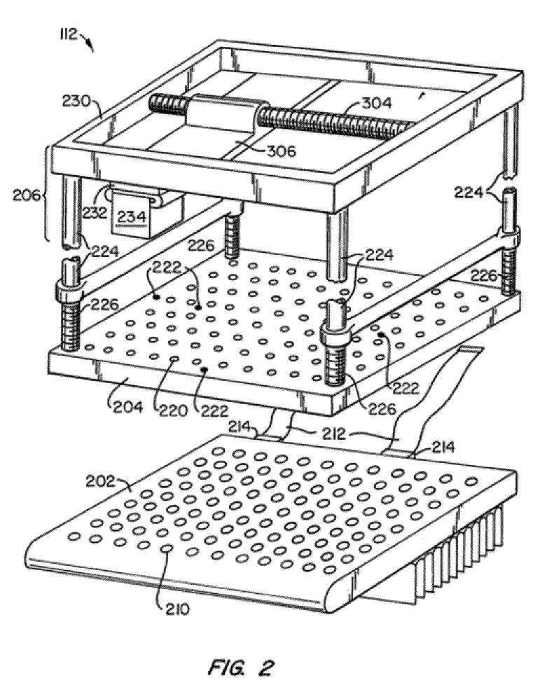

FIG. 2 is an exploded view of the inside of lid assembly 112. Shown are a sample unit 202, a lid heater 204, and a fluorometer assembly 206. Sample unit 202 contains a number of sample wells 210 arranged in a regular array (e.g., an 8×12 grid). In one embodiment, each sample well 210 holds a removable reaction vessel (not shown), such as a tube, that contains a nucleic acid sample to be tested, together with appropriate PCR reactants (buffers, primers and probes, nucleotides, and the like) including at least one fluorescent label or probe adapted to bind to or otherwise respond to the presence of a target nucleic acid sequence. The reaction vessels are advantageously provided with transparent sample caps (not shown) that fit securely over the tops of the vessels to prevent cross-contamination of samples or spillage during handling. Reaction vessels may also be sealed in other ways, including the use of films, wax products, or mineral oil. In an alternative configuration, a removable sample tray (not shown) that holds one or more distinct samples at locations corresponding to sample wells 210 is used. The sample tray may also be sealed in any of the ways described above.

Sample unit 202 also includes heating elements (e.g., Peltier-effect thermoelectric devices), heat exchange elements, electrical connection elements for connecting the heating elements to base unit 110, and mechanical connection elements. These components (not shown) may be of conventional design. Sample unit 202 also provides electrical connections for lid heater 204 and fluorometer assembly 206 via multiwire cables 212, which are detachably connected to connectors 214.

Lid heater 204 has holes 220 therethrough, matching the size and spacing of the sample wells 210, and electronically controlled heating elements (not shown). Lid heater 204 is coupled to lid 122. The coupling mechanism (not shown) is advantageously movable (e.g., lid heater 204 may be attached to lid 122 by a hinge) in order to provide access to fluorometer assembly 206 when lid 122 is removed from sample unit 202. When lid 122 is in place on sample unit 202, supports 224 hold lid heater 204 in position. Lower portions 226 of supports 224 are advantageously designed to compress lid heater 204 toward sample unit 202, thereby reducing the possibility of sample evaporation during operation of apparatus 100. This compression also allows reaction vessels of different sizes to be used. Lid heater 204 is used to control the temperature of the sample caps (or other sealants) of reaction vessels sample wells 210, in order to prevent condensation from forming on the caps during thermal cycling operation.

Lid heater 204 advantageously includes one or more calibration elements 222 positioned between selected ones of holes 220 or in other locations away from the holes, such as near the periphery of lid heater 204. Calibration elements 222 provide a known fluorescence response and may be used to calibrate fluorescence detectors in fluorometer assembly 206. Calibration elements 222 may be made, e.g., of a fluorescent coating on a glass or plastic substrate, or they may consist of a plastic with a dye impregnated in it, fluorescent glass, or a fluorescent plastic such as polyetherimide (PEI). Neutral-density or other types of filters may be placed over the fluorescent material in order to avoid saturating the fluorescence detectors. In general, any material may be used, provided that its fluorescence characteristics are sufficiently stable over time with the application of light (photo-bleaching) and heat. To the extent practical, the effect of temperature on the fluorescence response is advantageously minimized. Where multiple calibration elements 222 are provided, different materials may be used for different ones of the calibration elements. In an alternative embodiment, lid heater 204 may be omitted, and calibration elements 222 may be disposed on the surface of sample unit 202.

Sample unit 202 and lid heater 204 may be of conventional design, and a further description of these elements is omitted.

Detection Module with Diffuser System

Fluorometer assembly 206 includes a support frame or platform 230 fixedly mounted inside lid 122. Movably mounted on the underside of support frame 230 is a shuttle 232, which holds a detection module 234. Shuttle 232 is movable in two dimensions so as to position detection module 234 in optical communication with different ones of the sample wells 210 in sample unit 202 through the corresponding holes 220 in lid heater 204; for instance, the movable mounting described in U.S. Pat. No. 7,148,043 can be used. Support frame 230 and supports 224 are advantageously dimensioned such that when lid 122 is positioned in base unit 110 and closed, detection module 234 is held in close proximity to lid heater 204; one of skill in the art will appreciate that this arrangement reduces light loss between the sample wells and the detection module.

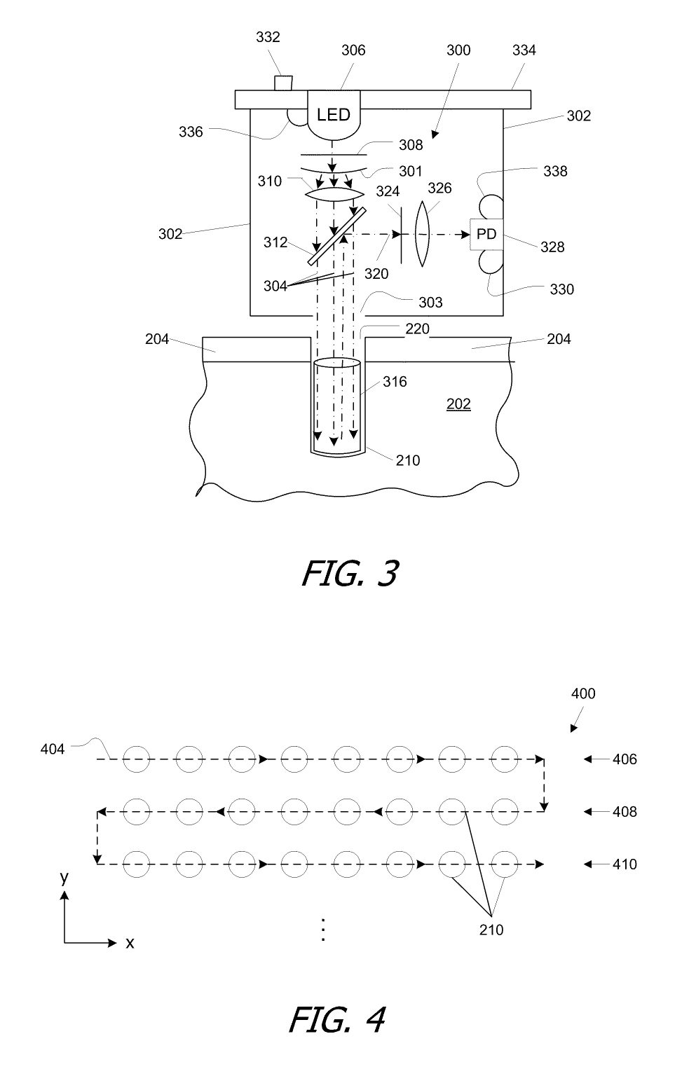

Detection module 234 is mounted on shuttle 232. (In some embodiments, detection module 234 can be mounted in a manner that facilitates detaching and replacing of detection module 234 by an experimenter, e.g., as described in U.S. Pat. No. 7,148,043, although this is not required.) Detection module 234 includes one or more excitation/detection channels (or “excitation/detection pairs”). As shown in FIG. 3, an excitation/detection pair 300 is arranged inside opaque walls 302, which provide optical isolation from other excitation/detection pairs that may be included in detection module 234, as well as from external light sources. An excitation light path 304 includes a light-emitting diode (LED) or other light source 306, a filter 308, a lens 310, and a beam splitter 312. A detection light path 320 includes beam splitter 312, a filter 324, a lens 326, and a photodiode or other photodetector 328. Beam splitter 312 is advantageously selected to be highly transparent to light of the excitation wavelength and highly reflective of light at the detection (fluorescent response) wavelength.

Light path 304 advantageously also includes a diffuser 301. Diffuser 301 is positioned in light path 304 so as to diffuse and homogenize the light from LED 306, for reasons described below. Diffuser 301 can be implemented in a variety of ways; in one embodiment, diffuser 301 is a holographic diffuser molded in thin plastic. Suitable diffuser elements are commercially available.

The components of excitation light path 304 are arranged to direct excitation light of a desired wavelength into a reaction vessel 316 held in a sample well 210 of sample block 202. The desired wavelength depends on the particular fluorescent labeling agents included in reaction vessel 316 and is controlled by selection of an appropriate LED 306 and filter 308. Optical communication between the excitation/detection pair 300 and reaction vessel 316 is provided by opening 303 in opaque walls 302 and a hole 220 through lid heater 204, as described above. To maximize light transmission to and from excitation/detection pair 300, the space between opening 303 and lid heater 204 is advantageously made small during operation.

Excitation light that enters reaction vessel 316 excites the fluorescent label or probe therein, which fluoresces, thereby generating light of a different wavelength. Some of this light exits reaction vessel 316 on detection light path 320 and passes through opening 303. Beam splitter 312 directs a substantial portion of the fluorescent light through filter 324, which filters out the excitation frequency, and lens 326, which focuses the light onto the active surface of photodiode 328. Photodiode 328 generates an electrical signal in response to the incident light. This electrical signal is transmitted by a readout signal path 330 to a circuit board 334, which routes the signal to electrical connector 332 for readout. The circuit board 334 and/or signal path 330 may also include other components, such as pre-amplifiers, for shaping and refining the electrical signal from photodiode 328.

LED 306 and photodiode 328 may be controlled by signals received via connector 332, as indicated by respective control signal paths 336, 338. Control signals for LED 306 may operate to activate and deactivate LED 306 at desired times; control signals for photodiode 328 may operate to activate and deactivate photodiode 328 at desired times, adjust a gain parameter, and so on.

While FIG. 3 shows one excitation/detection pair 300, it is to be understood that an embodiment of detection module 234 may contain any number of such pairs, each of which is advantageously in optical isolation from the others and has its own opening for optical communication with the sample wells. The various excitation/detection pairs can be independently controlled and independently read out.

The configuration of excitation/detection pairs may be varied from that shown, and the excitation and detection light paths may include additional components, fewer components, or any combination of desired components. The optics may be modified as appropriate for a particular application (e.g., the optical path may be shorter in embodiments where lid heater 204 is not included) and use any number and combination of components including but not limited to lenses, beam splitters, mirrors, and filters. While LEDs provide a compact and reliable light source, use of other types of coherent or incoherent light sources, such as laser diodes, flash lamps, and so on, is not precluded. Similarly, the detectors are not limited to photodiodes; any type of photodetector may be substituted, including photomultipliers and charge-coupled devices (CCDs). Each excitation/detection pair is advantageously configured as a self-contained assembly, requiring only external electrical connections to make it operational. Because the length of the excitation and detection optical paths do not vary from one experiment to the next, it is desirable to fixedly mount and optimize the various optical components of each excitation/detection pair 300 inside detection module 234 during manufacture so that further adjustments during operation are not required.

### Continuous Scanning Operation

By moving shuttle 232, detection module 234 can be placed successively in optical communication with each sample well 210 in an array of sample wells. FIG. 4 illustrates a scanning pattern according to an embodiment of the present invention. An array 400 of sample wells 210 is scanned by detection module 234 along serpentine path 404. Detection module 234 traverses the first row 406 of array 400 in a left-to-right direction along the x axis, interrogating each well 210 in row 406. At the end of row 406, detection module 234 shifts along they axis to align with second row 408, then scans the wells 210 in row 408 in a right-to-left direction along the x axis. At the end of row 408, detection module 234 again shifts along the y axis to align with third row 410, then scans the wells 210 in row 410 in a left-to-right direction along the x axis. This pattern can continue until all rows of array 400 are scanned. It is to be understood that array 400 can include any number of rows, and the number of wells per row can be varied.

In some embodiments, detection module 234 does not stop over each well 210. Instead, detection module 234 can move over the wells of a row at a constant speed. Light detector 304 is programmed to integrate the total light received while the module is passing over a well 210, report the data, and start integrating again at the next well 210. Light source 302 can be continuously on during this procedure, or it can be operated in a pulsed mode. Pulsed operation can reduce energy consumption and, depending on the light source, can also result in a brighter illumination of each well than would result if light source 302 is continuously on during the scan. In addition, pulsing light source 302 can also reduce cross talk between different sample wells 210. The pulsing of light source 302 and the integration time of detection module 234 can be adjusted to coincide with the passing of detection module 234 over each one of wells 210.

### Effects of Diffuser

Light source 302 is advantageously designed to produce a spot of light directed toward opening 310 of detection module 234. This spot can be about the same size as the area of sample well 210 that faces opening 303. But depending on the light source, the intensity of the light falling on a sample well might or might not be uniform across the illuminated area.

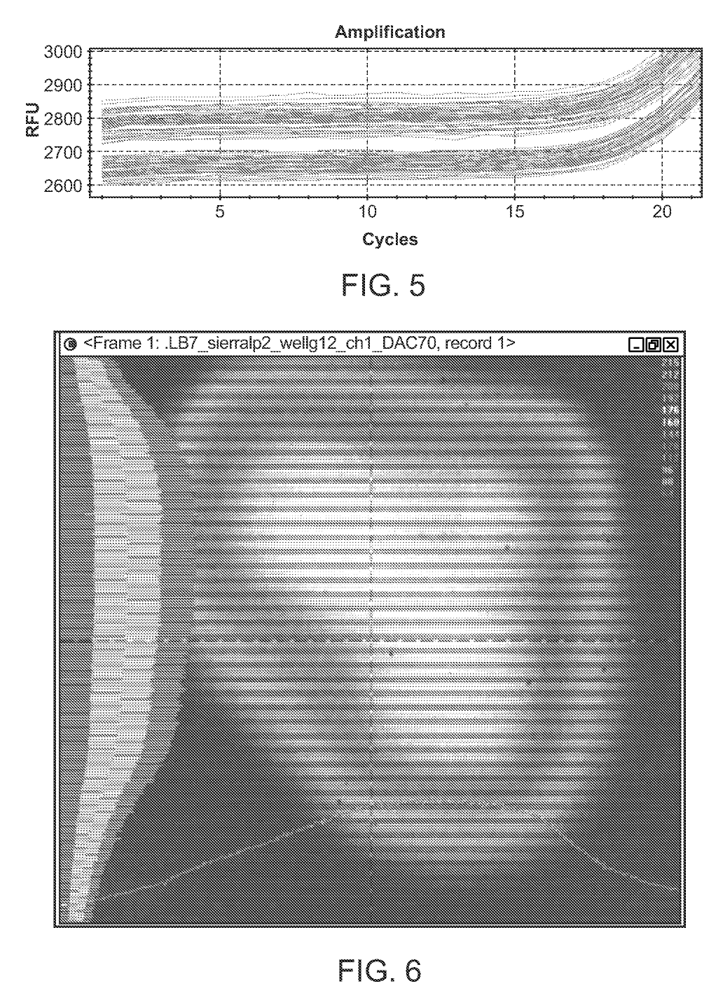

To the extent that the light intensity is not uniform, a “banding” effect can result. This effect is illustrated in FIG. 5. FIG. 5 is a graph showing amplification measurements (in relative fluorescence units, or “RFU”) as a function of number of cycles of a thermal cycler for each well of an array, as obtained from a test of the scanning fluorometer apparatus without diffuser 301 of FIG. 3. The measurements at each cycle are taken using a serpentine scan with substantially continuous motion as shown in FIG. 4, and each line on the graph represents the data obtained from a different well.

For this test, nearly identical initial samples were placed in each well. In spite of this, FIG. 5 shows that the measurements cluster into two bands. The clustering correlates with whether a well was scanned in a left-to-right or right-to-left direction.

Further analysis identified two sources for this banding effect. As noted above, the light source illuminates the sample for a finite time, and the light detector integrates received light over a finite time. The light detector used in this test has a standard RC (exponential) response to a square-wave input. But the light source (an LED) used in the test that produced FIG. 5 did not provide a square wave input. In fact, the illumination was non-uniform, as shown in FIG. 6. FIG. 6 shows light intensity as a function of position for the type of LED used in the test; the lighter areas correspond to higher intensity. As can be seen, the light is inhomogeneous: a strong light/dark pattern is visible. This inhomogeneity is characteristic of LEDs and arises from die shape and from the current distribution and light extraction techniques commonly used in LED manufacturing.

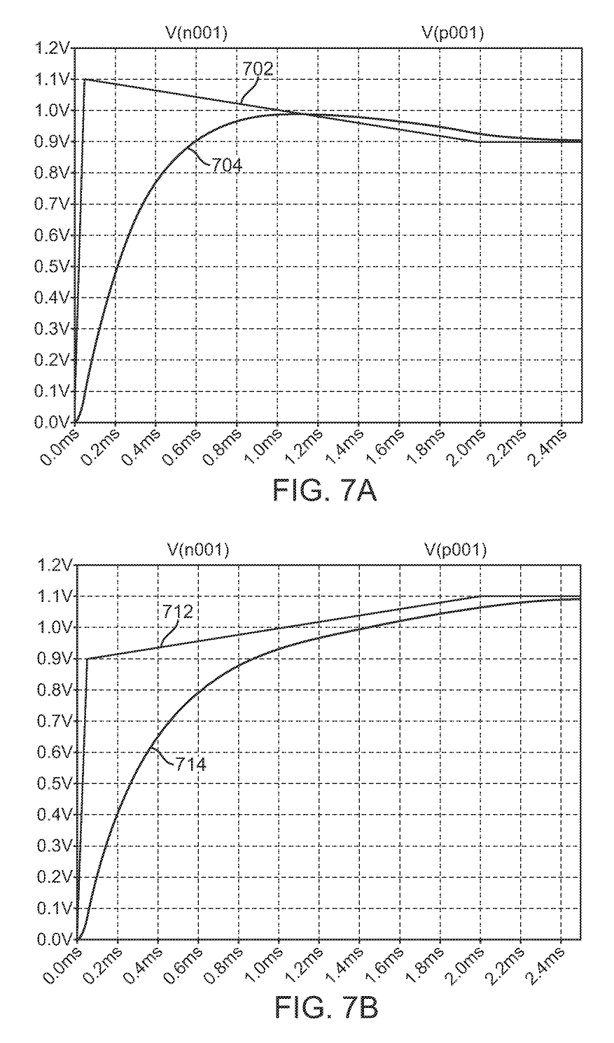

As a result of this inhomogeneity, the intensity of light received by a sample well as a function of time can depend on the direction in which the light source traverses the well. This effect has been simulated, and results are shown in FIGS. 7A and 7B. FIG. 7A is a graph showing light intensity (line 702) and simulated detector response (line 704) as a function of time for a case where the light source begins at maximum intensity and gradually decays to a lower steady state value. FIG. 7B is a graph showing light intensity (line 712) and simulated detector response (line 714) for a case where the light source begins at a lower intensity and ramps up to a maximum intensity. As noted above, the light detector integrates the response over a period of time. The simulations show that integral (the area under the curve) is different between line 704 of FIG. 7A and line 714 of FIG. 7B, even though the integrated light intensity (the area under the curve) is the same for line 702 of FIG. 7A and line 704 of FIG. 7B. Thus, the detector response depends on the light intensity as a function of time.

At least part of the banding effect shown in FIG. 5 is believed to result from this property. For instance, if the light source is brighter at the left than the right, then the light intensity as a function of time will depend on whether the light source traverses the well from left to right or from right to left. This will affect the detector response, as shown in FIGS. 7A and 7B.

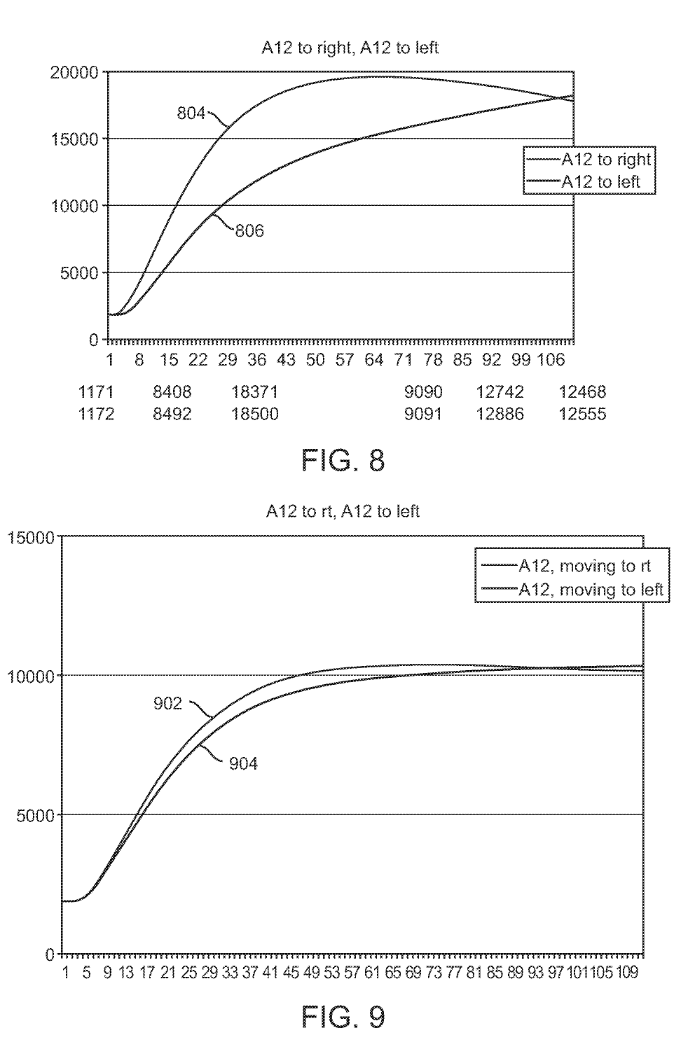

To directly test this hypothesis, individual sample wells were scanned in both left-to-right and right-to-left directions. FIG. 8 shows the result for a representative well. A detector response result is shown for one well, with line 804 corresponding to a right-to-left scan and line 806 corresponding to a left-to-right scan. A significant difference can be seen. This results from mechanical eccentricity as well as LED non-uniformity. However, the behavior matches the simulation (FIGS. 7A and 7B) well.

FIG. 9 shows the detector response resulting from scanning an individual sample well with essentially perfect mechanical center (no mechanical eccentricity) but without a diffuser. The difference between left-to-right scanning (line 902) and right-to-left scanning (line 904) is greatly reduced as compared to FIG. 8. Some difference persists and is believed to be due to inherent inhomogeneity of the light source.

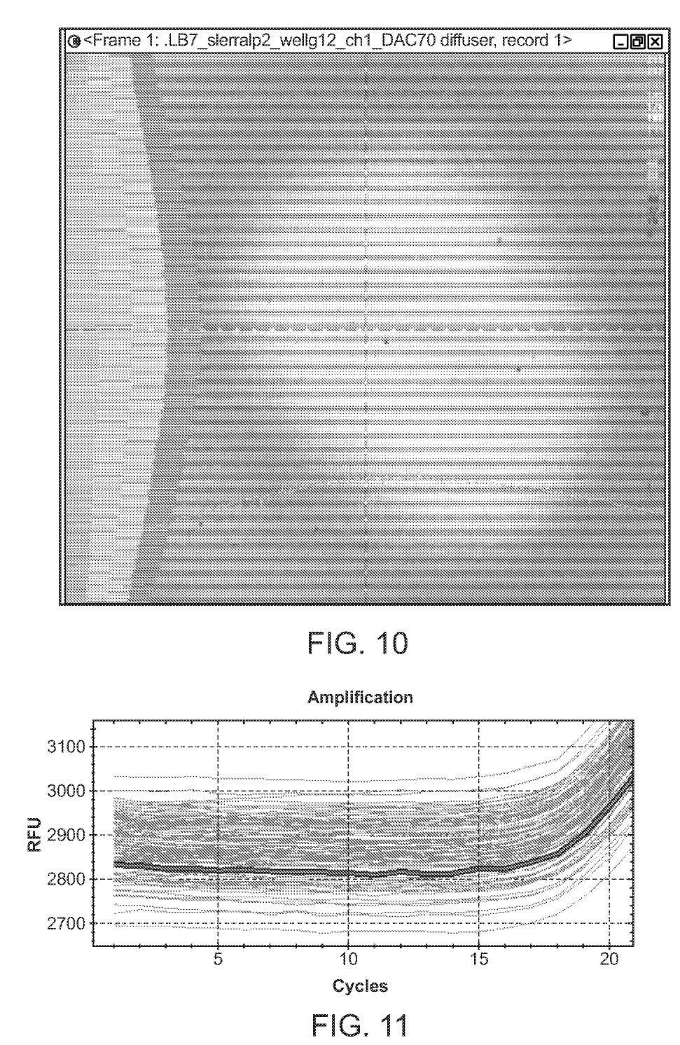

Adding a diffuser (e.g., diffuser 301 of FIG. 3) improves the uniformity of the light. FIG. 10 shows light intensity as a function of position for the same LED as in FIG. 6, but with a diffuser in place. The diffuser “homogenizes” the light intensity profile, weakening the strong pattern seen in FIG. 6 and reducing the difference in light intensity as a function of time between the right-to-left and left-to-right scanning directions.

In one embodiment, the diffuser has high nominal transmission (e.g., 80% or more) in order to reduce light loss. The diffusing angle should be less than 15 degrees (preferably between 1 and 10 degrees) so that most of the light reaches the target sample well. Also, the diffuser is advantageously thin and light so that it fits into a small detection module. For example, a 5-degree circular Light Shaping Diffuser (available from Physical Optics Corp./Luminit) can be used. The diffuser is advantageously fixed in place within the light path of detection module 234 (as shown in FIG. 3) so that its effect on the light source is constant.

FIG. 11 is a graph showing amplification measurements (in RFU) as a function of number of cycles of a thermal cycler for each well of an array, as obtained from a test of the scanning fluorometer apparatus with diffuser 301 of FIG. 3, under similar test conditions to those used in FIG. 5 (i.e., nearly identical samples in each well). As before, the measurements at each cycle are taken using a serpentine scan with substantially continuous motion as shown in FIG. 4, and each line on the graph represents the data obtained from a different well. The banding effect seen in FIG. 5 is greatly reduced.

It should be noted that the diffuser has little or no effect if detection module 234 is not in motion when sample wells are interrogated. In “step-and-repeat” scanning, detection module 234 is positioned over a well and stopped before the light source is pulsed. Since the light source is stationary while measurements are being taken, all sample wells are affected in the same way by any inhomogeneity. The step-and-repeat procedure, however, is slower than continuous-motion, or “flyover,” scanning because it takes time to accelerate and decelerate detection module 234 between each interrogation position.

### FURTHER EMBODIMENTS

While the invention has been described with respect to specific embodiments, one skilled in the art will recognize that numerous modifications are possible. For instance, in FIG. 3, diffuser 301 could be placed after lens 310 or before filter 308. Thus, although the invention has been described with respect to specific embodiments, it will be appreciated that the invention is intended to cover all modifications and equivalents within the scope of the following claims.

What is claimed is:

1. A fluorescence detection apparatus for analyzing samples located in a plurality of wells in a thermal cycler, the apparatus comprising:
a support structure attachable to the thermal cycler; and
a detection module movably mountable on the support structure, the detection module including:
an excitation light generator disposed within the detection module;
a diffuser placed in a light path leading from the excitation light generator to an opening in the detection module; and
an emission light detector disposed within the detection module;
wherein, when the support structure is attached to the thermal cycler and the detection module is mounted on the support structure, the detection module is movable so as to be positioned in optical communication with different ones of the plurality of wells,
the detection module being operable to interrogate different wells of the plurality of wells in succession while in motion over the plurality of wells.

2. The fluorescence detection apparatus of claim 1 wherein the detection module is operable to interrogate a well by pulsing the excitation light generator for a period of time and operating the emission light detector for a corresponding period of time to measure a time-integrated emission light signal.

3. The fluorescence detection apparatus of claim 1 wherein the diffuser has a diffusion angle between 1 and 10 degrees.

4. The fluorescence detection apparatus of claim 1 wherein the diffuser has a diffusion angle less than 15 degrees.

5. The fluorescence detection apparatus of claim 1 wherein positioning of the detection module with respect to the wells is controlled by an external computer.

6. The fluorescence detection apparatus of claim 1 wherein operation of the excitation light generator and the emission light detector is controlled by an external computer.

7. A fluorescence detection module for use in an apparatus for analyzing samples located in a plurality of wells in a thermal cycler, the detection module comprising:
a housing having an opening at one end thereof;
a fitting on an exterior surface of the housing, the fitting adapted to attach the detection module to a movable shuttle of a fluorescence analysis apparatus;
an excitation light generator mounted inside the housing such that an excitation optical path from the excitation light generator to the opening has a constant length;
a diffuser disposed on the excitation optical path; and
an emission light detector mounted inside the housing such that a detection optical path from the opening to the emission light detector has a constant length,
wherein when the detection module is attached to the movable shuttle, the opening is oriented toward the plurality of wells and the shuttle is movable to position the detection module in optical communication with different wells of the plurality of wells,
the detection module being operable to interrogate different wells of the plurality of wells in succession while in motion over the plurality of wells.

8. A method for detecting the presence of a target molecule in a solution, the method comprising:
preparing a plurality of samples, each containing a fluorescent probe adapted to bind to a target molecule;
placing each sample in a respective one of a plurality of sample wells of a thermal cycler instrument, the thermal cycler instrument having a detection module movably mounted therein, the detection module including an excitation/detection channel, the excitation/detection channel including an excitation light generator disposed within the detection module, a diffuser placed in a light path leading from the excitation light generator to an opening in the detection module, and an emission light detector disposed within the detection module;
stimulating a reaction using the thermal cycler instrument;
scanning the plurality of sample wells by moving the detection module such that the excitation/detection channel is sequentially positioned in optical communication with each of the plurality of sample wells; and
operating the detection module to interrogate each of the plurality of wells in turn, wherein the interrogation is performed while the detection module is in motion.

9. The method of claim 8 wherein operating the detection module to interrogate each of the plurality of wells includes:
pulsing the excitation light generator for a period of time; and
operating the emission light detector for a corresponding period of time to measure a time-integrated emission light signal.

10. The method of claim 8 wherein the target molecule is a nucleic acid sequence.

11. The method of claim 10 wherein the reaction is a polymerase chain reaction (PCR).
